(19) United States
(12) Patent Application Publication
(10) Pub. No.: US 2013/0195027 A1
(43) Pub. Date: Aug. 1, 2013

(54) Method and Apparatus for Channel Fallback in Enhanced Cell Forward Access Channel Dedicated Channel

(71) Applicants: Liangchi Hsu, San Diego, CA (US); Sitaramanjaneyulu Kanamarlapudi, San Diego, CA (US); Ravi Agarwal, San Diego, CA (US); Rohit Kapoor, San Diego, CA (US); Sharad Deepak Sambhwani, San Diego, CA (US); Arjun Bharadwaj, San Diego, CA (US)

(72) Inventors: Liangchi Hsu, San Diego, CA (US); Sitaramanjaneyulu Kanamarlapudi, San Diego, CA (US); Ravi Agarwal, San Diego, CA (US); Rohit Kapoor, San Diego, CA (US); Sharad Deepak Sambhwani, San Diego, CA (US); Arjun Bharadwaj, San Diego, CA (US)

(73) Assignee: QUALCOMM Incorporated, San Diego, CA (US)

(21) Appl. No.: 13/553,574

(22) Filed: Jul. 19, 2012

Related U.S. Application Data
(60) Provisional application No. 61/592,251, filed on Jan. 30, 2012.
(60) Provisional application No. 61/645,469, filed on May 10, 2012.

(51) Int. Cl. H04W 74/00

(52) U.S. Cl. CPC H04W 74/006
USPC 370/329

(57) ABSTRACT

The described aspects include a user equipment (UE) apparatus, network apparatus, and corresponding methods of using fallback resources for communication. The UE can indicate fallback information to a network apparatus specifying whether fallback resources are preferred for communicating uplink data and can receive a fallback decision from the network apparatus specifying whether fallback resources are to be used for communicating the uplink data. The UE can then determine whether to communicate the uplink data to the network apparatus based in part on the fallback decision. The network apparatus can receive a preamble from a UE related to requesting access for transmitting uplink data and can determine a fallback decision specifying whether the UE is to utilize fallback resources in communicating the uplink data. The network apparatus then communicates the fallback decision to the UE.

### CLAIM OF PRIORITY UNDER 35 U.S.C. §119

The present application for Patent claims priority to Provisional Application No. 61/592,251, entitled “METHOD AND APPARATUS FOR CHANNEL FALLBACK IN ENHANCED CELL FORWARD ACCESS CHANNEL DEDICATED CHANNEL,” filed Jan. 30, 2012, and Provisional Application No. 61/645,469, entitled “METHOD AND APPARATUS FOR CHANNEL FALLBACK IN ENHANCED CELL FORWARD ACCESS CHANNEL DEDICATED CHANNEL,” filed May 10, 2012, which are assigned to the assignee hereof and hereby expressly incorporated by reference herein.

### BACKGROUND

1. Field

Aspects of the present disclosure relate generally to wireless communication systems, and more particularly to communicating over access channels in cell forward access channel (CELL_FACH).

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks. Furthermore, UMTS supports multiple radio access bearer (multi-RAB) capability, which allows simultaneous network communication with a user equipment (UE) over two or more radio access bearers. Therefore, multi-RAB functionality in UMTS allows for a user equipment to concurrently transmit and receive packet-switched and circuit-switched data.

In some releases of 3GPP, such as release 8 (Rel-8), if a user equipment (UE) and network (NW), communicating using HSPA, support enhanced uplink (EUL) in cell forward access channel (CELL_FACH), the UE can transmit over a common enhanced dedicated channel (E-DCH) resource or high speed random access channel (HS-RACH) on the uplink in CELL_FACH. For example, the UE may not be allowed to transmit over other resources, such as 3GPP release 99 (Rel-99) RACH resources.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an example, fallback schemes are presented to allow a network (NW) to cause a user equipment (UE) to fallback to legacy resources in certain scenarios. For example, when a UE and NW are communicating using enhanced uplink (EUL) in cell forward access channel (CELL_FACH) state, the NW can command the UE to fallback to random access channel (RACH) resources of a legacy technology, such as Wideband-Code Division Multiple Access Release-99. In one example, the UE can specify a fallback indication in one or more messages to the NW.

In one aspect, a method for communicating in a wireless network is provided. The method includes indicating fallback information to a network component specifying whether fallback resources are preferred for communicating uplink data and receiving a fallback decision from the network component specifying whether fallback resources are to be used for communicating the uplink data. The method further includes determining whether to communicate the uplink data to the network component based in part on the fallback decision.

According to another aspect, a computer program product for communicating in a wireless network is provided having a non-transitory computer-readable medium with at least one instruction for indicating fallback information to a network component specifying whether fallback resources are preferred for communicating uplink data, at least one instruction for receiving a fallback decision from the network component specifying whether the fallback resources are to be used for communicating the uplink data, and at least one instruction for determining whether to communicate the uplink data to the network component based in part on the fallback decision.

Still in another aspect, a UE apparatus for communicating in a wireless network is provided including means for indicating fallback information to a network component specifying whether fallback resources are preferred for communicating uplink data and means for receiving a fallback decision from the network component specifying whether the fallback resources are to be used for communicating the uplink data. The UE apparatus further includes means for determining whether to communicate the uplink data to the network component based in part on the fallback decision.

Moreover, in an aspect, a UE apparatus for communicating in a wireless network is provided having at least one processor, and a memory coupled to the at least one processor. The at least one processor is configured to indicate fallback information to a network component specifying whether fallback resources are preferred for communicating uplink data, receive a fallback decision from the network component specifying whether the fallback resources are to be used for communicating the uplink data, and determine whether to communicate the uplink data to the network component based in part on the fallback decision.

In another aspect, a method for communicating with a user equipment (UE) in a wireless network is provided. The method includes receiving a preamble from a UE related to requesting access for transmitting uplink data and determining a fallback decision specifying whether the UE is to utilize fallback resources in communicating the uplink data. The method further includes communicating the fallback decision to the UE.

According to another aspect, a computer program product for communicating in a wireless network is provided having a non-transitory computer-readable medium with at least one instruction for receiving a preamble from a UE related to requesting access for transmitting uplink data, at least one instruction for determining a fallback decision specifying whether the UE is to utilize fallback resources in communicating the uplink data, and at least one instruction for communicating the fallback decision to the UE.

Still in another aspect, a UE apparatus for communicating in a wireless network is provided including means for receiving a preamble from a UE related to requesting access for transmitting uplink data and means for determining a fallback decision specifying whether the UE is to utilize fallback resources in communicating the uplink data. The UE apparatus further includes means for communicating the fallback decision to the UE.

Moreover, in an aspect, a UE apparatus for communicating in a wireless network is provided having at least one processor, and a memory coupled to the at least one processor. The at least one processor is configured to receive a preamble from a UE related to requesting access for transmitting uplink data, determine a fallback decision specifying whether the UE is to utilize fallback resources in communicating the uplink data, and communicate the fallback decision to the UE.

These and other aspects of the disclosure will become more fully understood upon a review of the detailed description, which follows.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic block diagram of one aspect of a system for indicating whether to use fallback resources in communicating between a user equipment (UE) and a network;

FIG. 2 illustrates example states for indicating a fallback decision to a UE for communicating with a network;

FIG. 3 is a flowchart of one aspect of an example methodology for determining whether to communicate based on a received fallback decision;

FIG. 4 is a flowchart of one aspect of an example methodology for indicating a fallback decision to a UE;

FIG. 5 is a schematic block diagram of one aspect of a system for determining whether to communicate with a network component based on a fallback decision;

FIG. 6 is a schematic block diagram of one aspect of a system for communicating a fallback decision;

FIG. 7 is a block diagram illustrating an example of a hardware implementation according to aspects described herein;

FIG. 8 is a block diagram conceptually illustrating an example of a telecommunications system according to aspects described herein;

FIG. 9 is a conceptual diagram illustrating an example of an access network according to aspects described herein;

FIG. 10 is a conceptual diagram illustrating an example of a radio protocol architecture for the user and control plane according to aspects described herein; and

FIG. 11 is a block diagram conceptually illustrating an example of a Node B in communication with a UE in a telecommunications system, according to aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Described herein are various aspects related to allowing fallback from a set of resources to a set of legacy resources for communicating new data and/or retransmitting data between a user equipment (UE) and a network (NW). For example, the set of resources can include enhanced cell forward access channel (CELL_FACH) enhanced data channel (E-DCH) resources, high speed random access channel (HS-RACH) resources, etc., and the set of legacy resources can include Wideband-Code Division Multiple Access (W-CDMA) release 99 (Rel-99) physical random access channel (PRACH) resources. For example, the enhanced CELL_FACH E-DCH/HS-RACH resources can correspond to those defined a release of 3GPP, such as release 8 (Rel-8), while the RACH resources of the legacy technology can correspond to an earlier release of 3GPP, such as Rel-99.

In one example, the UE can assist in implementing the fallback by providing a fallback indication to the NW, which the NW can consider in making a fallback determination for the UE. For example, the fallback indication can indicate whether the UE supports only E-DCH/HS-RACH resources or supports E-DCH/HS-RACH and/or the legacy resources. In an example, the UE can select the fallback indication based on a type of uplink data to be transmitted over the channel to the NW. The NW can base the fallback determination on other considerations as well, such as load balancing criteria. In addition, in one example, the UE can determine whether to obey the NW fallback determination or consider the determination as a non-acknowledgement for the data to be transmitted over the channel. Thus, the UE can implement the fallback to allow flexibility at the NW in assigning access channel resources to the UE.

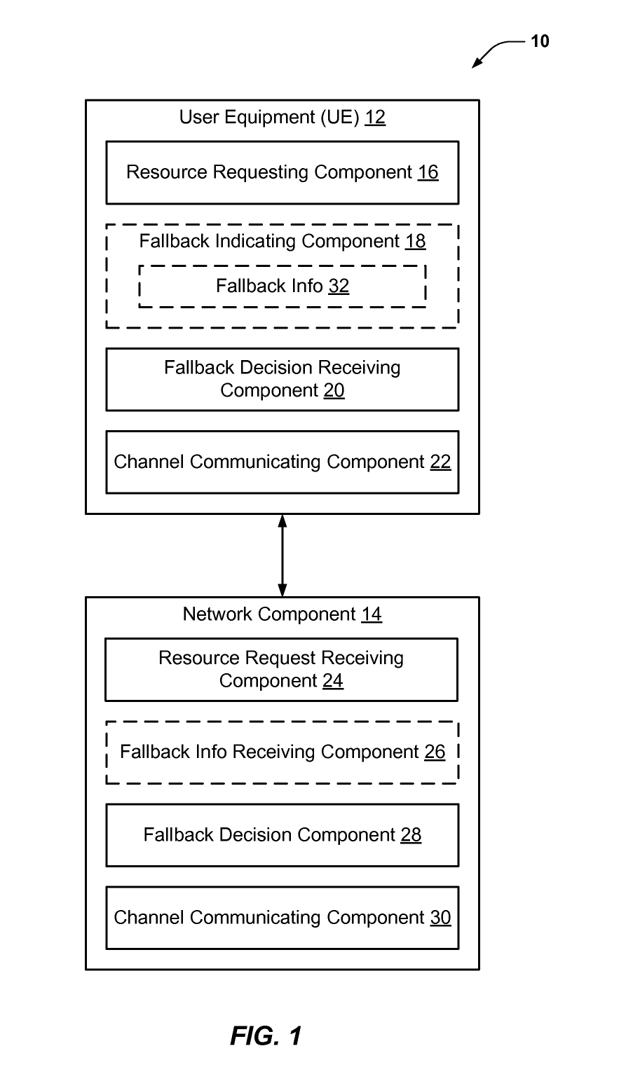

Referring to FIG. 1, in one aspect, a wireless communication system 10 includes a user equipment (UE) 12 for communicating with one or more network components 14 in a wireless network. For example, the network component 14 can be substantially any component of a wireless network, such as a Node B and/or Radio Network Controller (RNC), a relay, a UE that communicates in a peer-to-peer or ad-hoc mode with UE 12, one or more core network components, such as a gateway, mobility management entity (MME), and/or the like. For example, network component 14 can assign resources to UE 12 for communicating therewith, where the resources correspond to time/frequency resources that define one or more logical wireless channels. The wireless channels can include access channels (such as a RACH), CELL_FACH channels (such as E-DCH), and/or the like.

UE 12 includes a resource requesting component 16 for requesting communication resources from a network component, an optional fallback indicating component 18 for providing fallback information 32 to the network component, a fallback decision receiving component 20 for obtaining a fallback decision from the network component, and a channel communicating component 22 for transmitting data over a channel to the network component.

Network component 14 includes a resource request receiving component 24 for obtaining a request for communication resources from a UE for accessing network component, an optional fallback information receiving component 26 for obtaining fallback information 32 from the UE, a fallback decision component 28 for determining whether to allow the UE to fall back on legacy resources, and a channel communicating component 30 for receiving data from the UE over one or more channels.

According to an example, resource requesting component 16 can transmit a request for resources to network component 14. For example, this can include transmitting a RACH preamble over RACH resources of the network component 14 (e.g., using a preamble ramping procedure). A fallback indication related to whether UE 12 has the ability, or prefers, to fall back on legacy resources can be specified by the request. In one example, fallback indicating component 18 can generate fallback information 32 that can include the fallback indication for including in the request for resources. In another example, fallback indicating component 18 can indicate a fallback decision by a manner in which the request for resources is transmitted, such as by selecting one of multiple preamble scrambling codes, access slots, preamble signatures, or substantially any transmission parameter for the request for resources to differentiate the fallback indication. In either example, resource request receiving component 24 can obtain the request for resources, and fallback information receiving component 26 can determine a fallback indication from the request.

In one example, fallback information receiving component 26 can obtain the fallback indication from fallback information 32 within the request for resources or other message. In another example, fallback information receiving component 26 can determine the fallback information based on one or more aspects of the request as received from the UE 12. For example, fallback information receiving component 26 can determine a fallback indication based on a preamble scrambling code, access slot, preamble signature, etc. used to transmit the request. Thus, fallback information receiving component 26 can determine whether UE 12 is able to fall back on legacy resources based on the fallback indication, and fallback decision component 28 can use this information in determining whether to assign fallback resources to UE 12. Fallback decision receiving component 20 can obtain the fallback decision from network component 14, and can thus use fallback resources for at least one of communicating with network component 14 via channel communicating component 22 where assigned by network component 14, ignoring the fallback decision and not use the fallback resources, and/or the like.

It is to be appreciated that some UEs, such as legacy UEs, may not specify a fallback indication in a request for resources. In this example, fallback information receiving component 26 does not obtain a fallback indication. Thus, fallback decision component 28 can determine the UE is a legacy UE and assign resources other than fallback resources to the legacy UE.

In a specific example, UE 12 can communicate with network component 14 in a CELL_FACH state. In this example, where UE 12 and network component 14 support enhanced uplink (EUL), UE 12 and network component 14 can communicate over E-DCH/HS-RACH (e.g., via channel communicating components 22 and 30) or similar resources assigned to the UE 12 or otherwise advertised by network component 14. In addition, channel communicating component 22 can fall back to communicating with network component 14 over fallback resources (e.g., legacy resources, such as Rel-99 RACH) where the UE 12 and/or network component 14 determine to fall back. This allows more flexibility for network component 14 in assigning access channel resources, as the network component 14 can utilize the E-DCH/HS-RACH or Rel-99 RACH resources for communicating with UE 12.

In one example, UE 12 can generate uplink data for sending to the network component 14, which can be new data (e.g., received from an application or other higher communication layer), retransmission data (e.g., based on receiving an indication from network component 14 that previous data was not correctly received or decoded), and/or the like. In this regard, resource requesting component 16 can initiate a preamble ramping procedure to transmit a preamble to network component 14 to obtain resources over which to transmit the data. Preamble ramping can refer to transmitting preambles using increasing power until a response is received from network component 14 (e.g., and/or a threshold power or number of attempts is achieved).

Resource request receiving component 24 can obtain at least one of the one or more preambles from the ramping procedure, and fallback decision component 28 can determine whether to allow or otherwise cause UE 12 to use fallback resources (e.g., legacy resources) in communicating with network component 14. For example, fallback decision component 28 can determine such based in part on a load balancing algorithm or criteria corresponding to a load on network component 14. For instance, where one or more load criteria achieve a threshold, fallback decision component 28 can determine to allow or command UE 12 to operate using fallback resources. Thus, fallback decision component 28, in one example, can determine that UE 12 is to fall back to fallback resources. In one example, the fallback resources can use less bandwidth, and thus fallback decision component 28 can request or command UE 12 to use the fallback resources in an effort to conserve bandwidth utilized for communications between UE 12 and network component 14.

As described, fallback indicating component 18 can communicate fallback information 32 to network component 14. The fallback information 32 can include a fallback indication of the UE 12 as to whether the UE 12 can communicate over only non-fall back resources, such as E-DCH/HS-RACH, over non-fallback or fallback resources (e.g., legacy resources, such as Rel-99 RACH), and/or the like. As described, fallback indicating component 18 can indicate the fallback information 32 in the request or as a parameter used by resource requesting component 16 in generating the request for resources, such as a preamble scrambling code selection, access slot selection, preamble signature selection, etc. In any case, fallback information receiving component 26 can obtain the fallback information 32 from UE 12, and fallback decision component 28 can consider the fallback information 32 in determining whether to allow or otherwise command UE 12 to fall back to legacy resources (also referred to herein as fallback resources). Fallback decision component 28 can consider the fallback information 32 in addition or alternatively to the loading information and/or other parameters in determining whether to allow or command UE 12 to utilize fallback resources.

Fallback decision component 28 can indicate the fallback decision to UE 12, and fallback decision receiving component 20 can obtain the fallback decision, as described. In one example, fallback decision component 28 can communicate the fallback decision in an acknowledgement of receiving the preamble over an enhanced acknowledgement indicator channel (E-AICH). For example, fallback decision component 28 can specify a given enhanced acknowledgement indicator (E-AI) value for specifying whether to use fallback resources or that use of fallback resources is allowed with network component 14. In one example, fallback decision component 28 can utilize a non-acknowledgement (NACK) value to specify that fallback resources (e.g., Rel-99 PRACH resources) are to be utilized by UE 12, an acknowledgement (ACK) to specify otherwise, etc. Fallback decision receiving component 20 can obtain the E-AI value from the E-AICH transmitted by network component 14 and can determine whether to use fallback resources (e.g., Rel-99 PRACH resources) for communicating with network component 14 based on the E-AI value. In any case, for example, channel communicating component 22 can determine a channel for communicating data to network component 14 based on the fallback decision received from network component 14.

In one example, channel communicating component 22 can communicate data to network component 14 over uplink E-DCH/HS-RACH or legacy resources based on the fallback decision. For instance, where fallback decision receiving component 20 determines the fallback decision correlates to the fallback information 32 determined by fallback indicating component 18 (e.g., communicate over E-DCH/HS-RACH only, over E-DCH/HS-RACH or legacy RACH, etc.), channel communicating component 22 can transmit the data over a channel based on the fallback decision. Thus, where the fallback decision specifies that UE 12 is to fall back to fallback resources, channel communicating component 22 can communicate data over the fallback resources. In other examples, where fallback decision receiving component 20 determines the fallback decision does not align with the fallback indication in the fallback information 32, channel communicating component 22 can treat the acknowledgement within which the fallback decision is received as a non-acknowledgement (NACK) for the preamble, or can otherwise ignore the acknowledgement and refrain from communicating with network component 14 for a period of time.

In one example, fallback decision receiving component 20 receives a NACK in response to the request for resources as the indication to fall back to Rel-99 RACH resources; thus, in this example, channel communicating component 22 initiates a legacy back-off procedure defined for receiving NACK in response to RACH request over E-DCH/HS-RACH, such as reinitiating preamble ramp up after a specified period of time. In another example, where a NACK is received in response to the request for resources, channel communicating component 22 can use the back-off where resource requesting component 16 is requesting resources to transmit control data (e.g., over a common control channel (CCCH) or dedicated control channel (DCCH)). In this example, channel communicating component 22 can use the fallback resources where resource requesting component 16 is requesting resources to transmit non-control data (e.g., user-plane data over a dedicated traffic channel (DTCH)).

In one example, when using the fallback resources, variable radio link control layer (RLC) protocol data unit (PDU) size and/or media access control (MAC)-i/is segmentation may not be supported, and thus where the fallback decision indicates to use the fallback resources, channel communicating component 22 may or may not be able to communicate the data using the PDU size of the fallback resources. Thus, in certain situations, it can be beneficial for the fallback indicating component 18 to specify a fallback indication for E-DCH/HS-RACH only in fallback information 32 to avoid encountering this situation. For example, where the channel communicating component 22 has communicated a portion of new data to network component 14, fallback indicating component 18 can specify a fallback indication for E-DCH/HS-RACH only to network component 14 for subsequent communication of a remaining portion of the new data. Similarly, where channel communicating component 22 is communicating whole PDUs, the fixed size requirement of the RACH resources may not match that required for transmitting the whole PDUs, and in this situation, fallback indicating component 18 can similarly request E-DCH/HS-RACH only resources in the fallback information 32.

In another example, variable PDU and/or MAC-i/is segmentation may be supported over the fallback resources, and thus UE 12 may not indicate fallback information to the network component 14, and may obey the fallback decision of network component 14.

In addition, fallback decision component 28 can constrain switching between allowing or commanding UE 12 to use fallback resources and not so indicating based on a lapsed period of time from a previous switch to avoid ping-ponging between fallback and non-fallback resource assignments. For example, the period of time can be specified as an amount of time, a number of time transmit intervals (TTI), a number of allocations, and/or the like. In this example, fallback decision component 28 can further compare the period of time since a last switch from allowing or commanding fallback to not so indicating (or vice versa) to a threshold in determining whether to allow or command the UE 12 to use fallback resources (e.g., fallback decision component 28 can determine to allow or cause UE 12 to use fallback resources where the period of time achieves the threshold).

Though described generally in terms of E-DCH/HS-RACH resources and Rel-99 RACH resources above, it is to be appreciated that the concepts can be applied for substantially any set of resources as non-fallback resources, and legacy resources as the fallback resources.

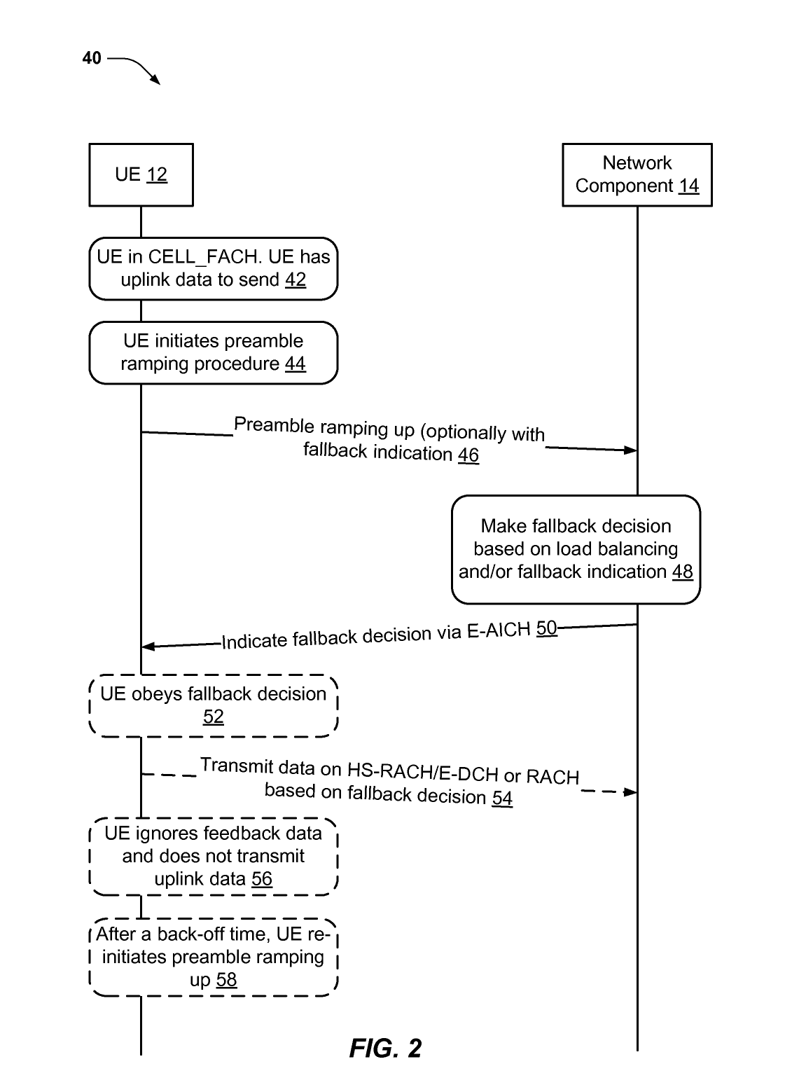

In FIG. 2, an example wireless communication system 40 is illustrated including a UE 12 that communicates with a network component 14, as described. At 42, the UE 12 is in CELL_FACH state (or in enhanced CELL_FACH state). UE 12 has uplink data to be sent. The uplink data can be new data or can be the retransmission data from the previous transmission. At 44, to transmit the uplink data, UE 12 starts the uplink preamble ramping up procedure, which can include the ramping up procedure of 3GPP Rel-8. When performing preamble procedure, the UE 12 can optionally specify its fallback indication (e.g., an ability or preference of fallback resources) at 46. For example, this can correspond to fallback information 32, as described.

In one example, the fallback indication of UE 12 can be an indication of support or preference for resources corresponding to at least one of: (a) E-DCH alone (e.g., UE 12 prefers to use Rel-8 HS-RACH/E-DCH for the upcoming uplink transmission); or (b) E-DCH or PRACH (e.g., UE has no preference of fallback resources for the upcoming uplink transmission). In one example, UE 12 indicates Option (a) for retransmission of previous data (e.g., to avoid PDU size mismatch, as described), and/or UE 12 indicates Option (b) for transmission of new data. Moreover, for example, at 46, the UE 12 can specify the fallback indication in the preamble ramp-up based on one of the following options: (1) using different preamble scrambling codes; (2) using different access slots; or (3) using different preamble signatures.

At 48, the network component 14 makes the fallback decision for whether to provide the UE 12 with fallback channel resources (e.g., either E-DCH alone—no fallback resources—or Rel-99 PRACH—fallback resources). The fallback decision at 48 can be based on the UE fallback preference or a load balancing criteria and/or algorithm at network component 14 (or additional considerations, such as a timing of a previous indication to fallback or not fallback, etc.). For example, if the network component 14 has at least a threshold load, network component 14 can determine the fallback decision as UE 12 using legacy resources for communicating with network component 14 (e.g., based on whether UE 12 indicates a preference for such or regardless). At 50, the network component 14 can indicate the fallback decision to the UE 12 via the acknowledge channel (for example, E-AICH channel in Rel-8). In one example, at 50, network component 14 uses NACK to indicate fallback.

Once the UE 12 has received the fallback decision from the network component 14 at 50, the UE 12 optionally can perform either steps 52 and 54 or steps 56 and 58 based on determining the fallback decision (e.g., determining to fallback if a NACK is received over E-AICH from network component 14). As an example, if the UE 12 fallback indication is the same as the network component 14 fallback decision (favorable for the UE 12), the UE 12 can perform step 52 and/or 54. On the other hand, if the UE 12 fallback indication is different from network component 14 fallback decision (not favorable for the UE 12), the UE 12 can perform step 56 and/or 58. At 52 and 54, the fallback decision is favorable for the UE 12. The UE 12 obeys the network component 14 fallback decision and starts transmitting uplink data accordingly. At 56 and 58, the fallback decision is not favorable for the UE 12, and in this case, UE 12 can treat the fallback decision as if a NACK was received in the current preamble procedure. Alternatively, the UE 12 can ignore the network component 14 fallback decision, at 56, and not transmit uplink data. After some back-off time, at 58, the UE 12 re-initiates the preamble ramping procedure at 42.

It is to be appreciated that if NACK is received over the E-AICH at 50, UE 12 can perform step 58 to perform a legacy back-off procedure defined for E-DCH in CELL_FACH if the preamble ramping up at 46 was for control channel resources (e.g., CCCH or DCCH). Where the preamble ramping up at 46 was for non-control resources (e.g., DTCH), UE 12 can obey the fallback decision at 52 and transmit data on the fallback RACH resources (e.g., Rel-99 RACH) at 54.

At 56 and 58, where the fallback decision is not favorable for the UE 12, but if the UE 12 still wants to transmit the uplink data (e.g., for the retransmission of previous RLC PDU), the UE 12 can retransmit the complete/entire PDU (if previously segmented) to ensure RLC data delivery with integrity.

As described, the above system 40 can be beneficial where the Rel-99 RACH resources use fixed RLC PDU size and/or do not allow MAC-i/is segmentation. Where the Rel-99 RACH resources allow for variable size RLC PDU and/or MAC-i/is segmentation, after step 50, the UE 12 can transmit using resources according to the fallback decision, and for retransmissions, can continue transmitting the retransmission PDUs on either HS-RACH/E-DCH or Rel-99 RACH based on the fallback decision.

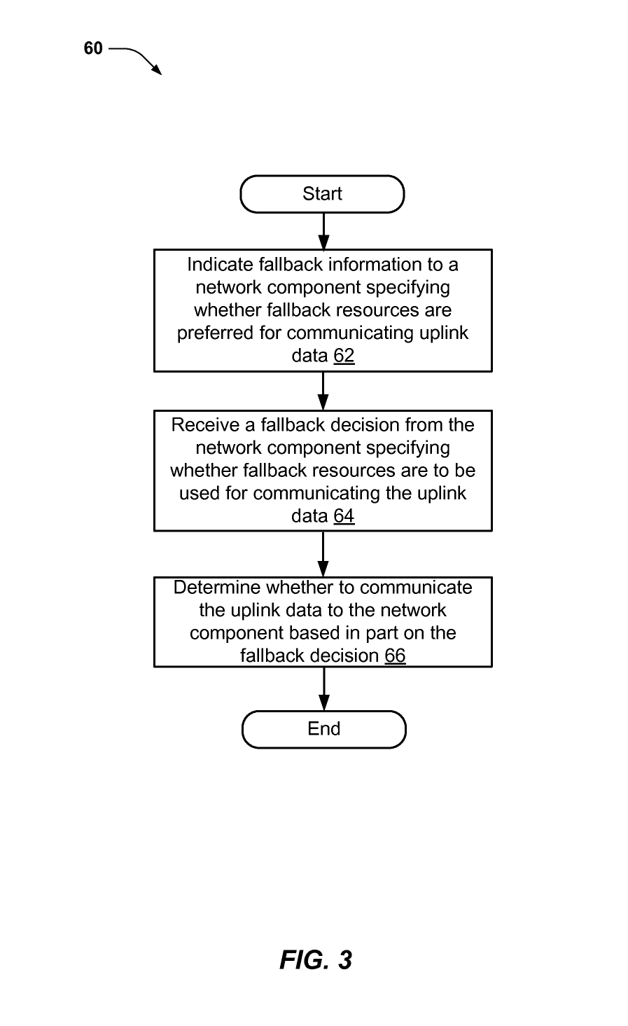

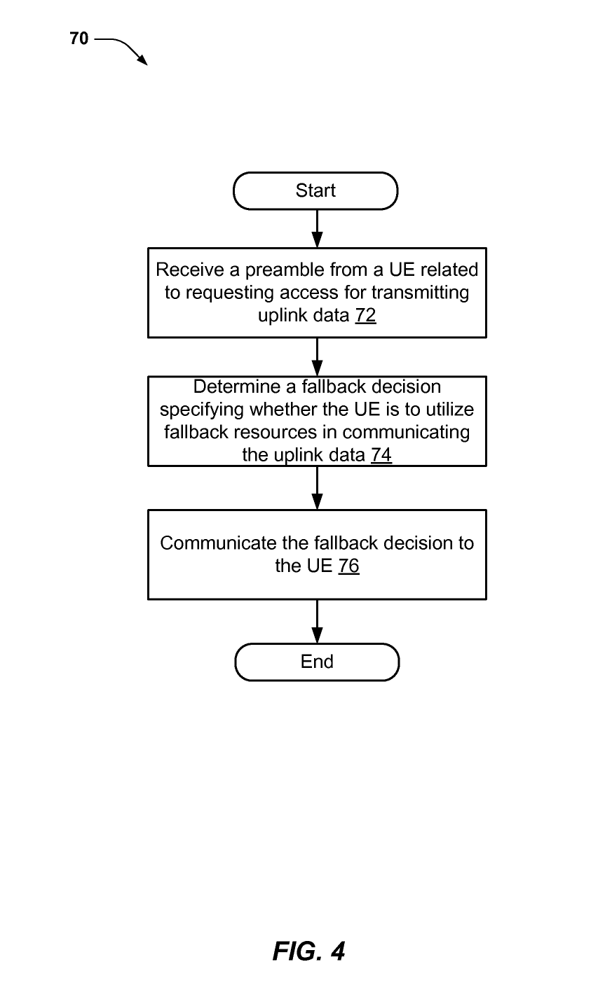

FIGS. 3-4 illustrate example methodologies for determining whether to communicate using fallback resources. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

Referring to FIG. 3, in one aspect, an example methodology 60 for communicating in a wireless network is illustrated.

At 62, fallback information can be indicated to a network component specifying whether fallback resources are preferred for communicating uplink data. For example, the fallback information can specify whether a UE prefers or otherwise supports fallback from non-fallback resources (such as E-DCH/HS-RACH resources) to fallback resources (such as Rel-99 RACH resources) or other legacy resources. In one example, fallback information can be indicated at 62 in one or more preambles transmitted as part of one or more preamble ramping procedures. This can include an explicit indication of the information in the preamble, using different preamble scrambling codes, access slots, or preamble signatures to indicate the fallback information, and/or the like.

At 64, a fallback decision can be received from the network component specifying whether fallback resources are to be used for communicating the uplink data. In one example, the fallback decision can be based in part on the fallback information indicated at 62. Moreover, the fallback decision can be received from the network component as an ACK or NACK for the preamble ramping procedure (e.g., over an E-AICH). The fallback decision can be indicated by the ACK/NACK or as a value in a corresponding message and/or otherwise derivable therefrom.

At 66, it can be determined whether to communicate the uplink data to the network component based in part on the fallback decision. As described, where the fallback decision coincides with the fallback information (e.g., a fallback indication in the fallback information), the UE can communicate with the network component according to the fallback decision. Where, however, the fallback decision does not coincide with the fallback information (e.g., the fallback decision indicates to fallback to Rel-99 RACH where the fallback information indicates a preference for E-DCH/HS-RACH only), the UE can ignore the fallback decision and not communicate with the network component, refrain from communicating with the network component for a period of time, treat the acknowledgement within which the fallback decision is received as a non-acknowledgement for the preamble procedure, etc. Moreover, the above functionality can be used when the fallback resources are fixed size and/or do not allow for MAC-i/is segmentation.

In one specific example, where the fallback decision is received as a NACK over a E-AICH, a legacy back-off procedure is initiated as part of determining whether to communicate at 66 where the uplink data is non-control data for transmission over a DTCH. Where the uplink data is control data, however, it can be determined to communicate the uplink data over fallback resources at 66.

Referring to FIG. 4, in one aspect, illustrated is a method 70 for communicating a fallback decision for a UE in a wireless network.

At 72, a preamble related to requesting access for transmitting uplink data can be received from a UE. As described, this can be part of a preamble ramping procedure, and channel resources can be granted to the UE based on receiving the preamble. For example, the preamble can be received over a RACH or E-DCH (e.g., where the UE is operating in CELL_FACH).

At 74, a fallback decision specifying whether the UE is to utilize fallback resources in communicating the uplink data can be determined. For example, the fallback decision can be determined based in part on one or more load criteria or algorithms. Moreover, in an example, fallback information can be received from the UE as part of the preamble at 72, and this information can additionally be utilized to determine the fallback decision. In yet another example, a period of time, number of TTIs, etc. since a previous change in fallback decision can be determined and utilized in determining the fallback decision to prevent frequent changing (e.g., ping-ponging) between fallback decisions.

At 76, the fallback decision can be communicated to the UE. For example, this can include specifying the fallback decision in an acknowledgement for the preamble (e.g., over a E-AICH). In one example, a NACK can be specified over the E-AICH to the UE to indicate fallback.

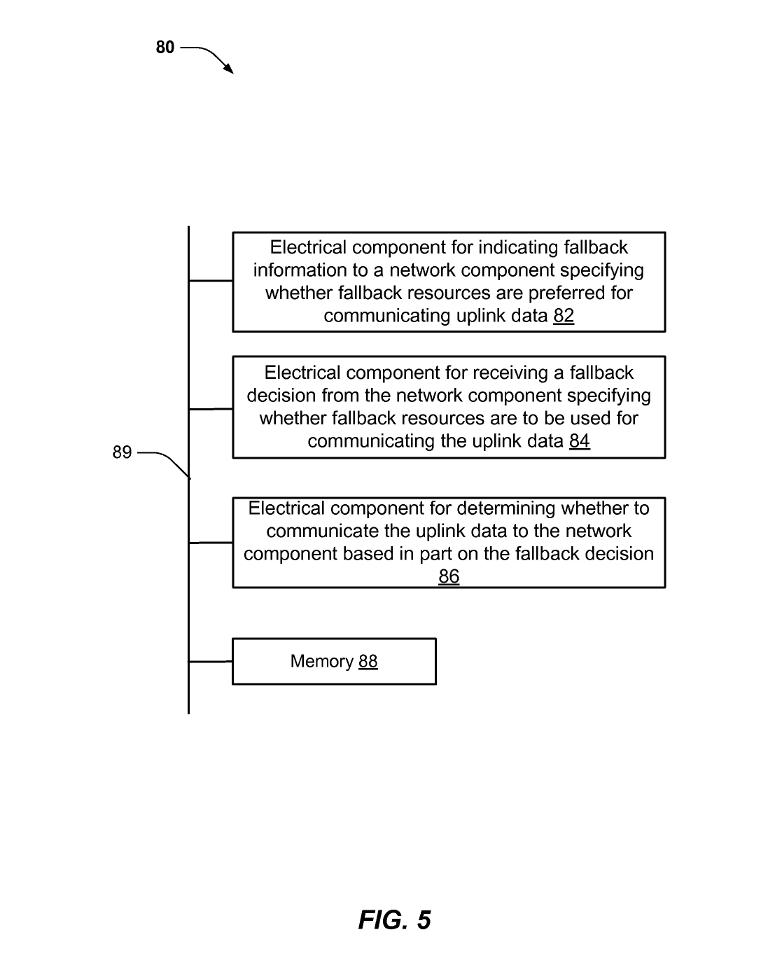

FIG. 5 illustrates an example system 80 for determining whether to communicate with a network component based on a fallback decision. For example, system 80 can reside at least partially within a UE. It is to be appreciated that system 80 is represented as including functional blocks, which can be functional blocks that represent functions implemented by a processor, software, or combination thereof (e.g., firmware). System 80 includes an electrical component for indicating fallback information to a network component specifying whether fallback resources are preferred for communicating uplink data 82, an electrical component for receiving a fallback decision from the network component specifying whether fallback resources are to be used for communicating the uplink data 84, and an electrical component for determining whether to communicate the uplink data to the network component based in part on the fallback decision 86. For example, electrical component 82 can correspond to a resource requesting component 16 or fallback indicating component 18, electrical component 84 can correspond to a fallback decision receiving component 20, and/or electrical component 86 can correspond to a channel communicating component 22.

Additionally, system 80 can include a memory 88 that retains instructions for executing functions associated with the electrical components 82, 84, and 86. While shown as being external to memory 88, it is to be understood that one or more of the electrical components 82, 84, and 86 can exist within memory 88. Electrical components 82, 84, and 86, in an example, can be interconnected over a bus 89 or similar connection to allow communication among the components. In one example, electrical components 82, 84, and 86 can comprise at least one processor, or each electrical component 82, 84, and 86 can be a corresponding module of at least one processor. Moreover, in an additional or alternative example, electrical components 82, 84, and 86 can be a computer program product comprising a computer readable medium, where each electrical component 82, 84, and 86 can be corresponding code.

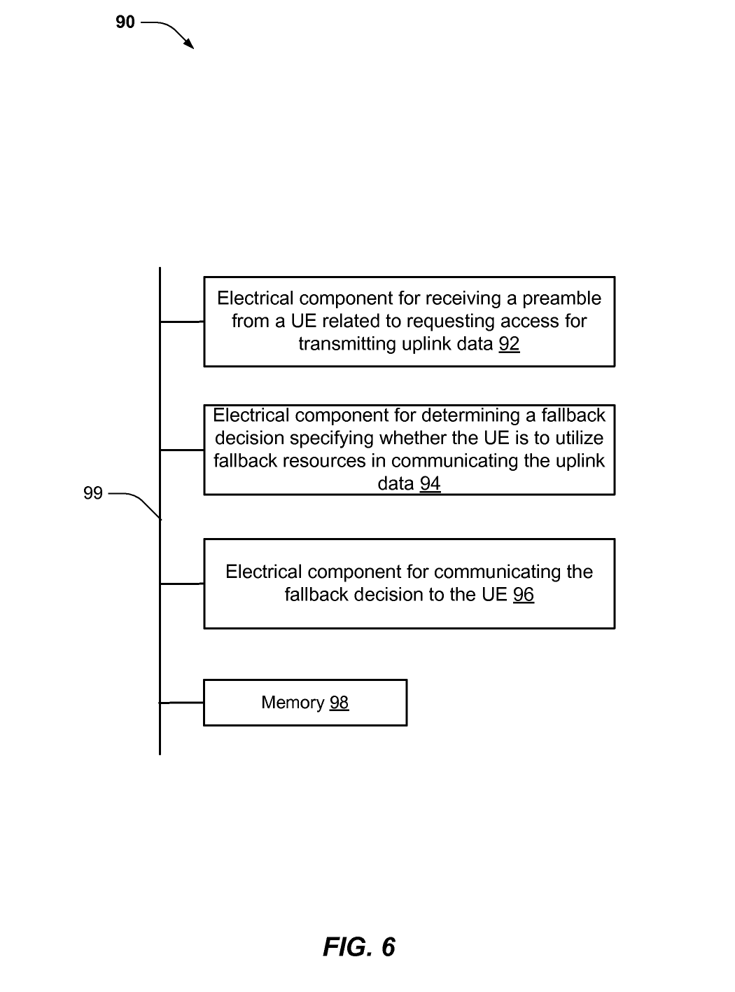

FIG. 6 illustrates an example system 90 for determining a fallback decision related to UE communications. For example, system 90 can reside at least partially within a wireless network (e.g., at a base station or other network component). It is to be appreciated that system 90 is represented as including functional blocks, which can be functional blocks that represent functions implemented by a processor, software, or combination thereof (e.g., firmware). System 90 includes an electrical component for receiving a preamble from a UE related to requesting access for transmitting uplink data 92, an electrical component for determining a fallback decision specifying whether the UE is to utilize fallback resources in communicating the uplink data 94, and an electrical component for communicating the fallback decision to the UE 96. For example, electrical component 92 can correspond to a resource request receiving component 24, electrical component 94 can correspond to a fallback information receiving component 26, and/or electrical component 96 can correspond to a fallback decision component 28.

Additionally, system 90 can include a memory 98 that retains instructions for executing functions associated with the electrical components 92, 94, and 96. While shown as being external to memory 98, it is to be understood that one or more of the electrical components 92, 94, and 96 can exist within memory 98. Electrical components 92, 94, and 96, in an example, can be interconnected over a bus 99 or similar connection to allow communication among the components. In one example, electrical components 92, 94, and 96 can comprise at least one processor, or each electrical component 92, 94, and 96 can be a corresponding module of at least one processor. Moreover, in an additional or alternative example, electrical components 92, 94, and 96 can be a computer program product comprising a computer readable medium, where each electrical component 92, 94, and 96 can be corresponding code.

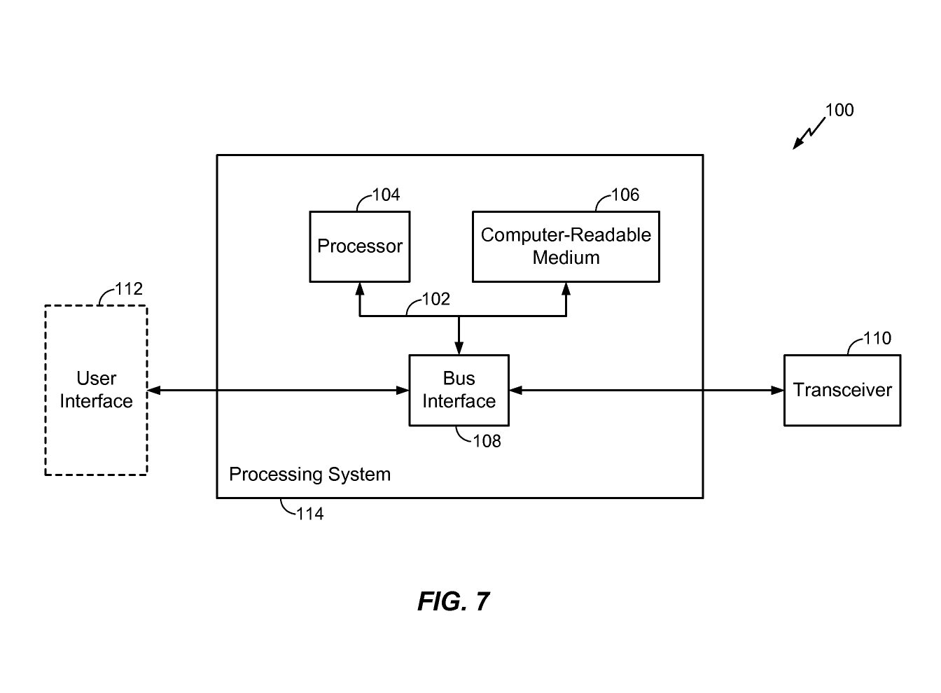

FIG. 7 is a block diagram illustrating an example of a hardware implementation for an apparatus 100 employing a processing system 114. For example, apparatus 100 may be specially programmed or otherwise configured to operate as UE 12, network component 14, etc., as described above. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software. In an aspect, for example, processor 104 and/or computer-readable medium 106 may be specially programmed or otherwise configured to operate as UE 12, network component 14, etc., as described above.

The various concepts presented throughout this disclosure may be implemented across a broad variety of telecommunication systems, network architectures, and communication standards.

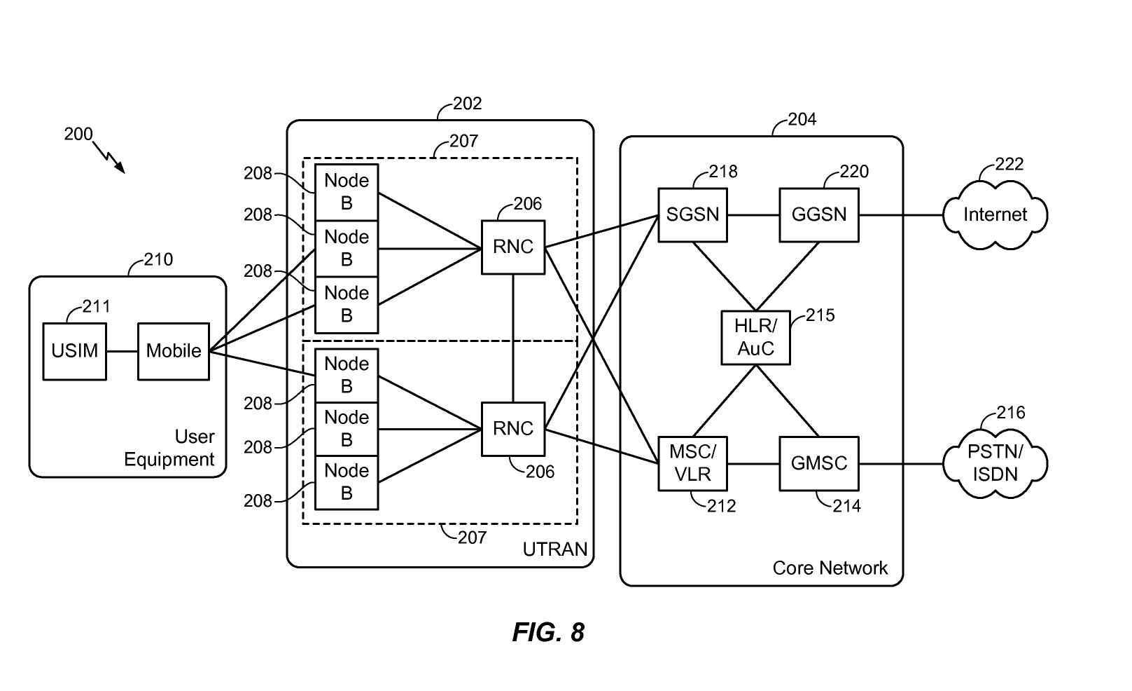

By way of example and without limitation, the aspects of the present disclosure illustrated in FIG. 8 are presented with reference to a UMTS system 200 employing a W-CDMA air interface. A UMTS network includes three interacting domains: a Core Network (CN) 204, a UMTS Terrestrial Radio Access Network (UTRAN) 202, and User Equipment (UE) 210. In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331 v9.1.0, incorporated herein by reference. Further, for example, UE 210 may be specially programmed or otherwise configured to operate as UE 12, and/or Node B 208 as network component 14, as described above.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a CN 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The DL, also called the forward link, refers to the communication link from a Node B 208 to a UE 210, and the UL, also called the reverse link, refers to the communication link from a UE 210 to a Node B 208.

The CN 204 interfaces with one or more access networks, such as the UTRAN 202. As shown, the CN 204 is a GSM core network. However, as those skilled in the art will recognize, the various concepts presented throughout this disclosure may be implemented in a RAN, or other suitable access network, to provide UEs with access to types of CNs other than GSM networks.

The CN 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a VLR that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The CN 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 210 provides feedback to the node B 208 over the HS-DPCCH to indicate whether it correctly decoded a packet on the downlink.

HS-DPCCH further includes feedback signaling from the UE 210 to assist the node B 208 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 208 and/or the UE 210 may have multiple antennas supporting MIMO technology. The use of MIMO technology enables the node B 208 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 210 to increase the data rate or to multiple UEs 210 to increase the overall system capacity. This is achieved by spatially precoding each data stream and then transmitting each spatially precoded stream through a different transmit antenna on the downlink. The spatially precoded data streams arrive at the UE(s) 210 with different spatial signatures, which enables each of the UE(s) 210 to recover the one or more the data streams destined for that UE 210. On the uplink, each UE 210 may transmit one or more spatially precoded data streams, which enables the node B 208 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

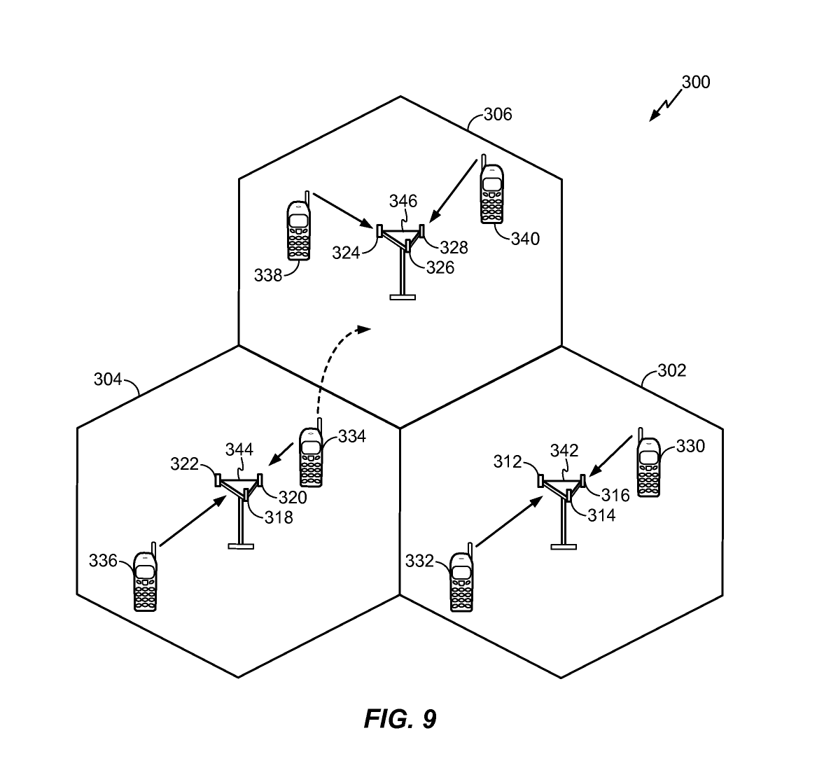

Referring to FIG. 9, an access network 300 in a UTRAN architecture is illustrated. The multiple access wireless communication system includes multiple cellular regions (cells), including cells 302, 304, and 306, each of which may include one or more sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a CN 204 (see FIG. 8) for all the UEs 330, 332, 334, 336, 338, 340 in the respective cells 302, 304, and 306. For example, in an aspect, the UEs of FIG. 9 may be specially programmed or otherwise configured to operate as UE 12, and/or Node Bs as network component 14, as described above.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 8), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

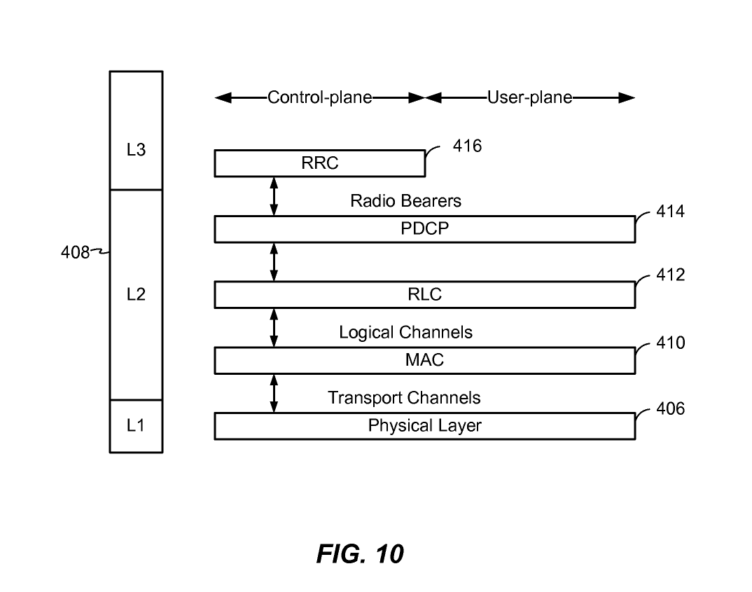

The radio protocol architecture may take on various forms depending on the particular application. An example for an HSPA system will now be presented with reference to FIG. 10. FIG. 10 is a conceptual diagram illustrating an example of the radio protocol architecture for the user and control planes.

Referring to FIG. 10, the radio protocol architecture for the UE and Node B is shown with three layers: Layer 1, Layer 2, and Layer 3. Layer 1 is the lowest lower and implements various physical layer signal processing functions. Layer 1 will be referred to herein as the physical layer 406. Layer 2 (L2 layer) 408 is above the physical layer 406 and is responsible for the link between the UE and Node B over the physical layer 406. For example, the UE corresponding to the radio protocol architecture of FIG. 10 may be specially programmed or otherwise configured to operate as UE 12, network component 14, etc., as described above.

In the user plane, the L2 layer 408 includes a media access control (MAC) sublayer 410, a radio link control (RLC) sublayer 412, and a packet data convergence protocol (PDCP) 414 sublayer, which are terminated at the node B on the network side. Although not shown, the UE may have several upper layers above the L2 layer 408 including a network layer (e.g., IP layer) that is terminated at a PDN gateway on the network side, and an application layer that is terminated at the other end of the connection (e.g., far end UE, server, etc.).

The PDCP sublayer 414 provides multiplexing between different radio bearers and logical channels. The PDCP sublayer 414 also provides header compression for upper layer data packets to reduce radio transmission overhead, security by ciphering the data packets, and handover support for UEs between node Bs. The RLC sublayer 412 provides segmentation and reassembly of upper layer data packets, retransmission of lost data packets, and reordering of data packets to compensate for out-of-order reception due to hybrid automatic repeat request (HARQ). The MAC sublayer 410 provides multiplexing between logical and transport channels. The MAC sublayer 410 is also responsible for allocating the various radio resources (e.g., resource blocks) in one cell among the UEs. The MAC sublayer 410 is also responsible for HARQ operations.

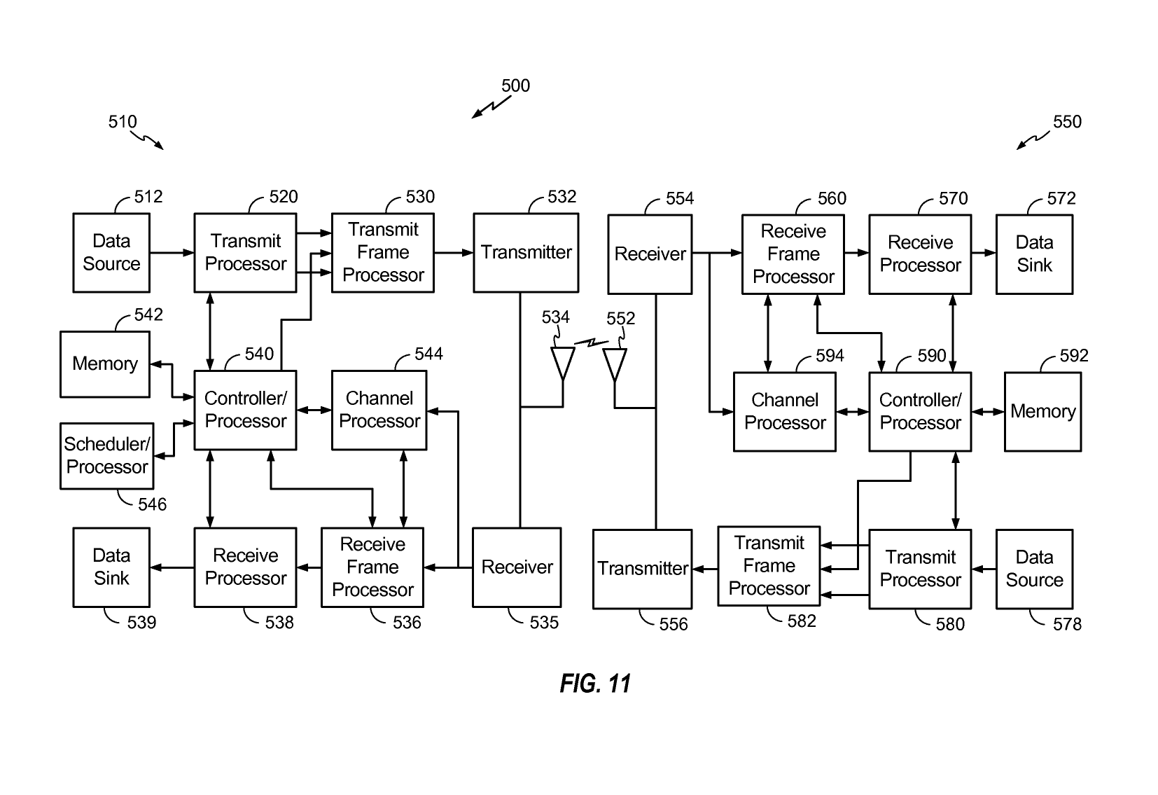

FIG. 11 is a block diagram of a system 500 including a Node B 510 in communication with a UE 550. For example, UE 550 may be specially programmed or otherwise configured to operate as UE 12, and/or Node B 510 as network component 14, as described above. Further, for example, the Node B 510 may be the Node B 208 in FIG. 8, and the UE 550 may be the UE 210 in FIG. 8. In the downlink communication, a transmit processor 520 may receive data from a data source 512 and control signals from a controller/processor 540. The transmit processor 520 provides various signal processing functions for the data and control signals, as well as reference signals (e.g., pilot signals). For example, the transmit processor 520 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 544 may be used by a controller/processor 540 to determine the coding, modulation, spreading, and/or scrambling schemes for the transmit processor 520. These channel estimates may be derived from a reference signal transmitted by the UE 550 or from feedback from the UE 550. The symbols generated by the transmit processor 520 are provided to a transmit frame processor 530 to create a frame structure. The transmit frame processor 530 creates this frame structure by multiplexing the symbols with information from the controller/processor 540, resulting in a series of frames. The frames are then provided to a transmitter 532, which provides various signal conditioning functions including amplifying, filtering, and modulating the frames onto a carrier for downlink transmission over the wireless medium through antenna 534. The antenna 534 may include one or more antennas, for example, including beam steering bidirectional adaptive antenna arrays or other similar beam technologies.

At the UE 550, a receiver 554 receives the downlink transmission through an antenna 552 and processes the transmission to recover the information modulated onto the carrier. The information recovered by the receiver 554 is provided to a receive frame processor 560, which parses each frame, and provides information from the frames to a channel processor 594 and the data, control, and reference signals to a receive processor 570. The receive processor 570 then performs the inverse of the processing performed by the transmit processor 520 in the Node B 510. More specifically, the receive processor 570 descrambles and despreads the symbols, and then determines the most likely signal constellation points transmitted by the Node B 510 based on the modulation scheme. These soft decisions may be based on channel estimates computed by the channel processor 594. The soft decisions are then decoded and deinterleaved to recover the data, control, and reference signals. The CRC codes are then checked to determine whether the frames were successfully decoded. The data carried by the successfully decoded frames will then be provided to a data sink 572, which represents applications running in the UE 550 and/or various user interfaces (e.g., display). Control signals carried by successfully decoded frames will be provided to a controller/processor 590. When frames are unsuccessfully decoded by the receiver processor 570, the controller/processor 590 may also use an acknowledgement (ACK) and/or negative acknowledgement (NACK) protocol to support retransmission requests for those frames.

In the uplink, data from a data source 578 and control signals from the controller/processor 590 are provided to a transmit processor 580. The data source 578 may represent applications running in the UE 550 and various user interfaces (e.g., keyboard). Similar to the functionality described in connection with the downlink transmission by the Node B 510, the transmit processor 580 provides various signal processing functions including CRC codes, coding and interleaving to facilitate FEC, mapping to signal constellations, spreading with OVSFs, and scrambling to produce a series of symbols. Channel estimates, derived by the channel processor 594 from a reference signal transmitted by the Node B 510 or from feedback contained in the midamble transmitted by the Node B 510, may be used to select the appropriate coding, modulation, spreading, and/or scrambling schemes. The symbols produced by the transmit processor 580 will be provided to a transmit frame processor 582 to create a frame structure. The transmit frame processor 582 creates this frame structure by multiplexing the symbols with information from the controller/processor 590, resulting in a series of frames. The frames are then provided to a transmitter 556, which provides various signal conditioning functions including amplification, filtering, and modulating the frames onto a carrier for uplink transmission over the wireless medium through the antenna 552.

The uplink transmission is processed at the Node B 510 in a manner similar to that described in connection with the receiver function at the UE 550. A receiver 535 receives the uplink transmission through the antenna 534 and processes the transmission to recover the information modulated onto the carrier. The information recovered by the receiver 535 is provided to a receive frame processor 536, which parses each frame, and provides information from the frames to the channel processor 544 and the data, control, and reference signals to a receive processor 538. The receive processor 538 performs the inverse of the processing performed by the transmit processor 580 in the UE 550. The data and control signals carried by the successfully decoded frames may then be provided to a data sink 539 and the controller/processor, respectively. If some of the frames were unsuccessfully decoded by the receive processor, the controller/processor 540 may also use an acknowledgement (ACK) and/or negative acknowledgement (NACK) protocol to support retransmission requests for those frames.

The controller/processors 540 and 590 may be used to direct the operation at the Node B 510 and the UE 550, respectively. For example, the controller/processors 540 and 590 may provide various functions including timing, peripheral interfaces, voltage regulation, power management, and other control functions. The computer readable media of memories 542 and 592 may store data and software for the Node B 510 and the UE 550, respectively. A scheduler/processor 546 at the Node B 510 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.”

Further, unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A method for communicating in a wireless network, comprising:
indicating fallback information to a network component specifying whether fallback resources are preferred for communicating uplink data;
receiving a fallback decision from the network component specifying whether the fallback resources are to be used for communicating the uplink data; and
determining whether to communicate the uplink data to the network component based in part on the fallback decision.

2. The method of claim 1, wherein the indicating the fallback information comprises indicating the fallback information in a preamble ramping procedure.

3. The method of claim 2, wherein the receiving the fallback decision comprises receiving the fallback decision as an acknowledgement or non-acknowledgement for the preamble ramping procedure.

4. The method of claim 3, further comprising communicating the uplink data over the fallback resources to the network component, wherein the fallback decision is received as a non-acknowledgement, and wherein the uplink data is control data.

5. The method of claim 3, further comprising initiating a back-off procedure for the preamble ramping procedure, wherein the fallback decision is received as a non-acknowledgement, and wherein the uplink data is non-control data.

6. The method of claim 2, wherein the indicating the fallback information comprises utilizing different preamble scrambling codes, different access slots, or different preamble signatures for a plurality of preambles in the preamble ramping procedure.

7. The method of claim 2, further comprising indicating non-acknowledgement for the preamble ramping procedure where the fallback decision specifies that the fallback resources are to be used for communicating the uplink data and the fallback information does not specify that the fallback resources are preferred for communicating the uplink data.

8. The method of claim 1, wherein the fallback resources comprise legacy random access channel resources.

9. The method of claim 1, further comprising communicating the uplink data to the network component over the fallback resources where the fallback decision specifies that the fallback resources are to be used for communicating the uplink data and the fallback information specifies that the fallback resources are preferred for communicating the uplink data.

10. The method of claim 1, further comprising refraining from communicating to the network component where the fallback decision specifies that the fallback resources are to be used for communicating the uplink data and the fallback information does not specify that the fallback resources are preferred for communicating the uplink data.

11. The method of claim 1, wherein the indicating the fallback information is based in part on whether the uplink data is new data or retransmission data.

12. A computer program product for communicating in a wireless network, comprising:
a non-transitory computer-readable medium, comprising:
at least one instruction for indicating fallback information to a network component specifying whether fallback resources are preferred for communicating uplink data;
at least one instruction for receiving a fallback decision from the network component specifying whether the fallback resources are to be used for communicating the uplink data; and
at least one instruction for determining whether to communicate the uplink data to the network component based in part on the fallback decision.

13. The computer program product of claim 12, wherein the at least one instruction for indicating indicates the fallback information in a preamble ramping procedure.

14. The computer program product of claim 12, wherein the at least one instruction for receiving receives the fallback decision as an acknowledgement or non-acknowledgement for the preamble ramping procedure.

15. The computer program product of claim 12, wherein the fallback resources comprise legacy random access channel resources.

16. A user equipment (UE) apparatus for communicating in a wireless network, comprising:
means for indicating fallback information to a network component specifying whether fallback resources are preferred for communicating uplink data;
means for receiving a fallback decision from the network component specifying whether the fallback resources are to be used for communicating the uplink data; and
means for determining whether to communicate the uplink data to the network component based in part on the fallback decision.

17. The UE apparatus of claim 16, wherein the means for indicating indicates the fallback information in a preamble ramping procedure.

18. The UE apparatus of claim 16, wherein the means for receiving receives the fallback decision as an acknowledgement or non-acknowledgement for the preamble ramping procedure.

19. The UE apparatus of claim 16, wherein the fallback resources comprise legacy random access channel resources.

20. A user equipment (UE) apparatus for communicating in a wireless network, comprising:
at least one processor; and
a memory coupled to the at least one processor,
wherein the at least one processor is configured to:
indicate fallback information to a network component specifying whether fallback resources are preferred for communicating uplink data;
receive a fallback decision from the network component specifying whether the fallback resources are to be used for communicating the uplink data; and
determine whether to communicate the uplink data to the network component based in part on the fallback decision.

21. The UE apparatus of claim 20, wherein the at least one processor indicates the fallback information in a preamble ramping procedure.

22. The UE apparatus of claim 20, wherein the at least one processor receives the fallback decision as an acknowledgement or non-acknowledgement for the preamble ramping procedure.

23. The UE apparatus of claim 20, wherein the fallback resources comprise legacy random access channel resources.

24. A method for communicating with a user equipment (UE) in a wireless network, comprising:
receiving a preamble from a UE related to requesting access for transmitting uplink data;
determining a fallback decision specifying whether the UE is to utilize fallback resources in communicating the uplink data; and
communicating the fallback decision to the UE.

25. The method of claim 24, wherein the determining the fallback decision is based in part on one or more load balancing criteria.

26. The method of claim 24, wherein the communicating the fallback decision comprises communicating the fallback decision as an acknowledgement or non-acknowledgment to the preamble.

27. The method of claim 24, further comprising determining fallback information from the UE based in part on the preamble, wherein the fallback information specifies whether the UE prefers to utilize the fallback resources in transmitting the uplink data.

28. The method of claim 27, wherein the determining the fallback information comprises determining the fallback information based on at least one of different preamble scrambling codes, access slots, or preamble signatures used for a plurality of preambles received from the UE.

29. The method of claim 24, wherein the fallback resources comprise legacy random access channel resources.

30. The method of claim 24, wherein the determining the fallback decision is based in part on a number of time transmit intervals, a period of time, or a number of fallback decisions since a previous fallback decision resulted in switching of whether to utilize the fallback resources.
